(19) United States
(12) Patent Application Publication
(10) Pub. No.: US 2025/0020542 A1
(43) Pub. Date: Jan. 16, 2025

(54) METHOD FOR MONITORING A WEAR STATE OF A GAS PATH CONTROL DEVICE, CONTROL DEVICE FOR CARRYING OUT SUCH A METHOD AND ENERGY CONVERSION DEVICE HAVING SUCH A CONTROL DEVICE

(71) Applicant: Rolls-Royce Solutions GmbH, Friedrichshafen (DE)

(72) Inventors: Egon Theil, Friedrichshafen (DE); Michael Dobrowolski, Tettnang (DE); Joachim Thiesemann, Friedrichshafen (DE)

(73) Assignee: Rolls-Royce Solutions GmbH, Friedrichshafen (DE)

(21) Appl. No.: 18/735,713

(22) Filed: Jun. 6, 2024

Related U.S. Application Data
(63) Continuation of application No. PCT/EP2022/085364, filed on Dec. 12, 2022.

(30) Foreign Application Priority Data
Dec. 13, 2021 (DE) 10 2021 132 840.3
Dec. 12, 2022 (WO) PCT/EP2022/085364

(51) Int. Cl. G01M 13/021; G01M 13/04

(52) U.S. Cl. CPC G01M 13/021; G01M 13/04

(57) ABSTRACT

A method for monitoring a wear state of a gas path control device of an energy conversion device having a gas path includes the steps of: detecting, in a time-dependent manner, an actuator position of an actuator that is for adjusting an actuating element of the gas path control device; determining at least one wear state parameter based on the actuator position which is detected in a time-dependent manner; and determining the wear state by way of the at least one wear state parameter.

### CROSS REFERENCE TO RELATED APPLICATIONS

This is a continuation of PCT application no. PCT/EP2022/085364, entitled “METHOD FOR MONITORING A WEAR STATE OF A GAS PATH CONTROL DEVICE, CONTROL DEVICE FOR CARRYING OUT SUCH A METHOD AND ENERGY CONVERSION DEVICE HAVING SUCH A CONTROL DEVICE”, filed Dec. 12, 2022, which is incorporated herein by reference. PCT application no. PCT/EP2022/085364 claims priority to German patent application no. 10 2021 132 840.3, filed Dec. 13, 2021, which is incorporated herein by reference.

### BACKGROUND OF THE INVENTION

### 1. Field of the Invention

The present invention relates to energy conversion devices.

### 2. Description of the Related Art

Components of energy conversion devices that are subject to wear, such as the gas path control device referred to herein, are not normally monitored for their wear state, but are replaced according to predetermined operating time intervals, in particular according to a predetermined maintenance schedule. As a precautionary measure, the selected operating time intervals are thereby shorter than would be required for an actual service life of the respective components. This leads generally to high maintenance and life cycle costs, as well as potentially also to unexpected failures of the affected components, with the associated disadvantages, especially downtimes.

What is needed in the art is a method for monitoring a wear state of a gas path control device of an energy conversion device having a gas path, a control device which is designed to carry out such a method and an energy conversion device with a gas path having a gas path control device and such a control device, wherein the aforementioned disadvantages are at least reduced, optionally do not occur.

### SUMMARY OF THE INVENTION

The present invention relates to a method for monitoring a wear state of a gas path control device of an energy conversion device having a gas path, a control device which is designed to carry out such a method and an energy conversion device with a gas path having a gas path control device and such a control device.

The present invention provides a method for monitoring a wear state of gas a path control device of an energy conversion device including a gas path, including the following steps: time dependent detection of an actuator position of an actuator that is intended for adjusting an actuating element of the gas path control device; on the basis of the actuator position detected in a time-dependent manner, at least one wear state parameter is determined, and on the basis of at least one wear state parameter, the wear state is determined. With the assistance of this method, the wear state of the gas path control device can be monitored during its operation in a simple and cost-effective manner, so that the gas path control device can be replaced as needed, depending on its actual state of wear. This eliminates the need for rigid maintenance intervals that are commonly too short because of safety concerns, and unexpected breakdowns are effectively avoided, as the actual wear and tear can be determined at any point in time. In particular, the maintenance and lifecycle costs associated with the gas path control device can be reduced.

The wear state is determined in particular during operation of the gas path control device. In particular, the state of wear is continuously determined during operation of the gas path control device, in particular in an event-driven manner, at regular intervals, or continuously.

In one embodiment of the method, at least one measure is taken, depending on the detected wear state. The at least one measure is optionally selected from a group consisting of: issuing a warning to an operator of the gas path control device; issuing a replacement warning or request to the operator to replace the gas path control device; switching an operation of an energy conversion device incorporating the gas path control device to a safe operating mode; and shutting down the energy conversion device. Rigid maintenance and/or replacement intervals as well as unexpected failures of the gas path control device can in particular be avoided in this manner. In one embodiment of the method, the at least one measure is taken if the wear state exceeds a predetermined wear state threshold value.

In one embodiment of the method, the wear state of the actuator is determined as the wear state. In particular, the wear state of a gearing, in particular a gear wheel of the actuator, is optionally determined as the wear state.

In the context of the present teaching, a gas path control device is understood in particular to mean a flap device, in particular a throttle flap or exhaust flap, or a valve device, in particular a throttle valve or a Wastegate valve.

The gas path control device includes in particular the actuating element and the actuator which is drive-operatively connected with the actuating element, and which is arranged to adjust the actuating element. The actuator is designed, in particular, to be controllable.

The actuator includes in particular a motor in combination with gearing, in particular a gear wheel, wherein the motor is drive-operatively connected with the actuating element via the gearing. The actuating element is optionally associated with a rack that engages with the gearwheel. In particular, the gearing includes the gearwheel and the rack, which engage with each other, in other words, mesh with each other.

The actuator motor is in particular an electric motor, optionally a stepping motor or a servo motor.

The actuating element is in particular a flap element, or a valve piston or valve tappet.

In the context of the present technical teaching a gas path is understood, in particular to be an air path or a charging path, or an exhaust air path or exhaust gas path of the energy conversion device.

In the context of the present technical teaching, an energy conversion device is understood to be a device which is designed to convert a first form of energy into a second form of energy which is different from the first form of energy-either directly or via at least one intermediate step, meaning at least one additional form of energy.

The energy conversion device is designed in particular to convert chemical energy into electrical and/or mechanical energy.

The energy conversion device is in particular an internal combustion engine or a fuel cell.

In the context of the present technical teaching, an actuator position is understood to be a momentary actuator position, in particular an internal position, in particular an angular position or an angle of rotation relative to a reference-angular position which is detected in a time-dependent manner. Due to the fact that the at least one wear state parameter is determined on the basis of the actuator position that is determined in a time dependent manner, it is understood in the context of the present technical teaching that, in particular the at least one wear state parameter is derived directly from the time-dependently detected actuator position, or that the at least one wear state parameter is derived indirectly from the time-dependently detected actuator position, in particular with the assistance of intermediate steps, in particular by way of predetermined calculations into which the time-dependently detected actuator position is incorporated. In particular, the at least one wear state parameter is determined on the basis of a temporal change in the actuator position.

In embodiment of the method, the at least one wear state parameter is determined by way of a temporal derivative of the actuator position, in particular by way of the first temporal derivative of the actuator position.

According to a further development of the present invention it is provided that, as the at least one wear state parameter, at least one state parameter is determined which is selected from a group consisting of: a bearing state parameter of a bearing arrangement, in particular of a radial bearing arrangement of the gas path control device; and a gearing state parameter of a gearing of the actuator.

In particular, a bearing state parameter, in particular of a radial bearing arrangement of the actuator, in particular of the gearing, in particular the gear wheel, is determined.

Alternatively, or in addition, a bearing state parameter of a bearing arrangement in particular a radial bearing arrangement of the actuating element is determined.

In particular, a gearing state parameter of the gear wheel of the actuator is determined.

In one embodiment of the method, both state parameters-the bearing state parameter and the gearing state parameter—are determined as wear state parameters.

In one embodiment of the method, the two status parameters are ORed with each other, that is, they are treated in the relationship of a logical OR to each other, in order to decide on further measures depending on the status parameter that indicates greater wear.

According to one further development of the present invention it is provided that the at least one wear state parameter is compared with a predetermined wear state parameter threshold value, wherein the wear state is determined on the basis of the comparison.

In one embodiment of the method the wear state is determined as an absolute or relative deviation between the wear state parameter and the predetermined wear state parameter threshold value. The absolute deviation is generated in that the wear state parameter is subtracted from the predetermined wear state parameter threshold value. The relative deviation is generated in particular, in that the wear state parameter is divided by the predetermined wear state parameter threshold value.

In one embodiment of the method the at least one action is taken in the event that the at least one wear state parameter exceeds the predetermined wear state parameter threshold value.

In one embodiment of the method, wherein the wear state is determined as an absolute deviation between the wear state parameter and the predetermined wear state parameter threshold value, the predetermined wear state threshold value is optionally zero. In one embodiment of the method, wherein the wear state is determined as a relative deviation between the wear state parameter and the predetermined wear state parameter threshold value, the predetermined wear state threshold value is optionally 1. However, the wear state threshold value may of course also be selected in another way.

In one embodiment of the method, each of the two determined state parameters-that is, the bearing state parameter and the gearing state parameter—are compared with an associated predetermined wear state parameter threshold value, from which respectively a separate comparison result is gained. In each case, the comparison result is determined in particular—as explained above for the wear state—as an absolute or relative deviation of the respective state parameter from the wear state parameter threshold value assigned to it. Optionally, the comparison result that is closer to the wear state threshold value is used as the wear state. In this way, the two state parameters are ORed and the state parameter that indicates greater wear is always used for a decision regarding further actions.

According to a further development of the present invention, it is provided that a bearing state parameter of a bearing arrangement, in particular a radial bearing, of the gas path control device is determined as the at least one wear state parameter, in that a momentary load variable of the gas path control device is determined on the basis of the time-dependently detected actuator position, wherein the momentary load variable is temporally integrated, from which a load integral is obtained as the bearing state parameter. By temporally integrating the momentary load value, information about the wear state of the gas path control device, particularly the cumulative wear state, can advantageously be obtained.

According to a further development of the present invention, it is provided that the momentary load variable is determined as a product of a temporal derivative of the actuator position with a resistivity. This presents an especially beneficial opportunity for determination of the momentary load variable. In particular, the first temporal derivative of the actuator position is used as the temporal derivative of the actuator position. In particular, the speed of a change in the actuator position in combination with the resistivity is therefore considered. Optionally, the temporal derivative of the actuator position is a sign-free measure for the temporal derivative, in particular a magnitude or an even power, in particular square of the time derivative of the actuator position, or a root function of the even power, is used.

In the context of the present technical teaching, a resistivity is understood in particular to be a physical value that is characteristic of a force counteracting a change in the actuator position and/or stressing the bearing arrangement. In particular, the resistivity is a force or pressure value, in particular a counterpressure or a characteristic value of the counterpressure. In one embodiment of the method, an exhaust back pressure is used as the resistivity. In particular, if the gas path control device is arranged in an exhaust gas path of the energy conversion device, the actuating element must be relocated directly against the exhaust gas back pressure, or the bearing arrangement is subjected to stress by the exhaust gas back pressure. In another embodiment of the method, a representative pressure value, in particular a boost pressure, is used as the resistivity, in particular as a measure of the exhaust back pressure. This is advantageous in as far as with internal combustion engines a pressure sensor is typically provided for detecting the boost pressure, but no separate pressure sensor for detection of the exhaust gas back pressure. Since however, the exhaust gas back pressure correlates with the charging pressure, the charging pressure can be used in a simpler and more cost effective manner as a substitutive resistivity. If the gas path control device is arranged in an air path or a charging path of the energy conversion device, the charging pressure can be used in particular directly as resistivity.

In one embodiment of the present invention, the bearing state parameter is calculated as load integral L according to the following equation:

$$L = \int \vert \frac{d}{dt} {x}_{a} ( t ) \vert w ( t ) dt ,$$

where xa(t) is the time-dependently detected actuator position and w (t) is also the time-dependent resistivity, in particular the exhaust gas back pressure or—in particular representatively—the boost pressure.

According to a further development of the present invention, it is provided that a gearing state parameter of the gearing, in particular of the gear wheel of the actuator, is determined as the at least one wear state parameter, in that a regulating interval of the actuator is divided into a plurality of partial regulating intervals, wherein a momentary partial regulating interval of the actuator is detected in a time dependent manner as the actuator position. A frequency distribution of wear-critical events is determined as the at least one gearing state parameter, wherein the wear-critical events are selected from a group consisting of: acceptance of a wear-critical partial regulating interval by the actuator, and a wear-critical partial regulating interval change. The wear-critical events are always counted, and a frequency distribution is determined, in particular according to a histogram. In this manner, information regarding the wear of the actuator gearing can be advantageously obtained. In particular, the wear state parameter is derived from the frequency distribution, or the frequency distribution is used as wear state parameter.

Alternatively, or additionally, an absolute frequency of the wear-critical events is determined. In this manner, the wear state parameter can be easily determined as the absolute frequency and thus, valid information regarding the wear of the gearing can be obtained. The absolute frequency is determined optionally as sum of the frequency distribution, in particular the sum of all wear-critical events, or as a sum of all considered wear-critical events.

In the context of the present technical teaching, a regulating interval of the actuator is understood to be a complete regulating distance from a first end position, in particular a first end stop, to a second end position, in particular a second end stop, which the actuator can cover during operation of the gas path control device for the adjustment of the actuating element. The regulating interval can be stated, in particular in angular degrees or in percentages, wherein in the latter case, for example the first end position can be allocated a 0% value and the second end position a 100% value. In one embodiment of the method, the regulating interval is taught once, or at predetermined times, or event-controlled, in particular by way of a teaching run of the actuator, in particular by the actuator covering the regulating distance from the first end position to the second end position-or vice versa, or in both directions. In one embodiment of the method, it is provided that the regulating interval is taught each time the energy conversion device is switched on or started. In this manner, the regulating interval can be advantageously adapted to changing ancillary conditions, in particular contaminations of the gas path control device.

In one embodiment of the method the regulating interval is divided into the plurality of partial regulating intervals so that single-tooth engagement on the one hand and double-tooth engagement on the other hand can be assigned respectively to the partial regulating intervals. However, it is also possible for a change between a single-tooth engagement and a double-tooth engagement to occur in a partial regulating interval. The gear wheel of the actuator and an associated mating gearing element, in particular the rack, are designed, arranged and coordinated with each other in such a way that at most two directly adjacent teeth of the gearwheel are always in engagement with the mating gearing element, wherein only one tooth of the gearwheel is in engagement with the mating gearing element over a larger proportion of partial sections of the regulating distance, and wherein two directly adjacent teeth of the gearwheel are in engagement with the mating gearing element only for a smaller proportion, in particular a minority, of partial sections of the regulating distance. A singe-tooth engagement is herein understood in particular that only one tooth of the gear meshes with the mating gearing element, in particular the rack. A double-tooth engagement is herein understood that two directly adjacent teeth of the gear are simultaneously meshing with the mating gearing element, in particular the rack.

The fact that the actuator occupies a wear-critical partial regulating interval is understood to mean in the context of the present technical teaching that the momentary actuator position—static or, in particular, transient—corresponds to a wear-critical partial regulating interval. In other words, the actuator is arranged in the wear-critical partial regulating interval with respect to its momentary actuator position. A wear-critical partial regulating interval change is understood to mean that the actuator position changes between two immediately adjacent partial regulating intervals, whereby this change is classified as being wear-critical.

A shift between a single-tooth engagement and a double-tooth engagement is considered wear-critical, because this changeover causes a bending load change at the associated teeth, constituting a wear-relevant mechanical load and in particular a major wear mechanism of the gear wheel.

In particular, wear-critical partial regulating interval changes are now identified within the scope of the method. In particular, partial regulating interval changes, that is, such changes from one partial regulating interval to a directly adjacent next partial regulating interval, are identified as wear-critical in which a change between a single-tooth engagement and a double-tooth engagement occurs. A wear-critical partial regulating interval change is thus in particular a change between a first partial regulating interval and a second partial regulating interval immediately adjacent to the first partial regulating interval, in which either a single-tooth engagement exists in the first partial regulating interval and a double-tooth engagement exists in the second partial regulating interval, or vice versa, a single-tooth mesh exists in the second partial regulating interval and a double-tooth engagement exists in the first partial regulating interval.

Alternatively, or in addition, wear-critical partial regulating intervals are identified within the scope of the method. In particular, those partial regulating intervals are identified as being wear critical, inside of which a change occurs between a single-tooth engagement and a double-tooth engagement, regardless of the direction of said change.

According to a further development of the present invention it is provided that the frequency distribution of the wear-critical events is determined in a tooth-specific manner for a plurality of teeth of the gearing, in particular of the gear wheel of the actuator.

Alternatively, or in addition, the frequency distribution is determined in a tooth-pair specific manner for a plurality of pairs of directly adjacent teeth of the gearing, in particular of the gear wheel.

Alternatively, or in addition it is provided, that the frequency distribution of wear-critical events is determined globally for the gearing, in particular for the gear wheel.

Alternatively, or in addition, the absolute frequency of wear-critical events is determined in a tooth-individual manner for teeth of the gearing, in particular for the gear wheel of the actuator. Alternatively, or in addition the absolute frequency is determined in a tooth-individual manner for precisely one tooth of the gearing, in particular for the gear wheel.

Alternatively, or in addition, the absolute frequency is determined in a tooth-pair specific manner for a plurality of pairs of directly adjacent teeth of the gearing, in particular of the gear wheel. Alternatively, or in addition, the absolute frequency is determined in a tooth-pair specific manner for precisely one pair of directly adjacent teeth of the gearing, in particular of the gear wheel.

Alternatively, or in addition the absolute frequency of wear-critical events is determined globally for the gearing, in particular for the gear wheel.

According to a further development of the present invention it is provided that the actuator position is detected by the actuator itself. This presents an especially simple and, at the same time, reliable method for determining the actuator position. The actuator position is detected optionally by the actuator itself if the actuator has a stepping motor or a servo motor as its motor. The actuator position is detected in particular by the stepping motor or the servo motor.

According to a further development of the present invention it is provided that the wear state is determined locally in a control device of an energy conversion device that includes the gas path control device. This presents an especially simple and inexpensive manner of determining the wear state.

Alternatively, or in addition, the wear state is determined remotely from the energy conversion device, in particular in a remote computing device, in particular a provider or in a data cloud which is also referred to as Cloud. In particular, a plurality of wear states of a plurality of gas path control devices of a plurality of energy conversion devices is determined remotely from the energy conversion devices. In this way, a large amount of data regarding wear of gas path devices can advantageously be collected and evaluated, in particular statistically evaluated. In particular, valid values for the wear state threshold value and/or the wear state parameter threshold value can be advantageously derived from this, especially with a view to replacing gas path control devices not too frequently on the one hand, but not too late on the other by avoiding unexpected failures.

The present invention also provides a control device for an energy conversion device, wherein the energy conversion device includes a gas path, which in turn includes a gas path control device. The control device is designed to carry out an inventive method or a method according to one or several of the previously described embodiments. Advantages arise in connection with the control device, which were already discussed in connection with the method.

The control device includes at least one interphase, producing an operative connection with a gas path control device, in particular with an actuator of a gas path control device.

In one embodiment of the control device, said control device is arranged to determine the wear state locally.

In another embodiment of the control device, said control device includes a communication module which is arranged to interact with a remote computing device in a data transferring manner, in order to determine the wear state.

Ultimately the present invention also provides an energy conversion device with a gas path, including a gas path control device, wherein the energy conversion device includes an inventive control device or a control device according to one or more of the previously described embodiments. Advantages arise in connection with the energy conversion device which were already discussed in connection with the method and/or in connection with the control device.

The gas path control device includes in particular an actuating element and an actuator which is operatively drive-connected with the actuating element, wherein the actuator is designed to adjust the actuating element. The actuator is designed, in particular, to be controllable.

The actuator includes in particular a motor in combination with gearing, in particular a gear wheel, wherein the motor is drive-operatively connected with the actuating element via the gearing. The actuating element optionally has a rack assigned to it which engages with the gear wheel. The gearing includes in particular the gear wheel and the rack which engage with each other, in other words, mesh with each other.

The motor of the actuator is in particular an electric motor, optionally a stepping motor or a servo motor.

The actuating element is optionally a flap element, or a valve piston or valve tappet.

The control device is in particular operatively connected with the gas path control device, in particular with the actuator, in particular in order to control the actuator and optionally to receive the actuator position from the actuator.

The energy conversion device is designed in particular to convert chemical energy into mechanical and/or electrical energy. In one embodiment, the energy conversion device is in the embodiment of an internal combustion engine, in particular a piston engine. In another embodiment, the energy conversion device is in the embodiment of a fuel cell.

In one embodiment of the energy conversion device the gas path is an air path or a charging path of the energy conversion device. In another embodiment the gas path is an exhaust air or exhaust gas path of the energy conversion device.

In one embodiment of the energy conversion device the gas path control device is a flap device, in particular a throttle flap or exhaust flap, or a valve device, in particular a throttle valve or a Wastegate-valve.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of one design example of an energy conversion device, with one design example of a control device and a gas path control device;

FIGS. 2A, 2B each is schematic representation of a gas path control device;

FIG. 3 is a schematic representation of a first part of a design example of a method for monitoring a wear state of the gas path control device;

FIG. 4 is a second representation of a second part of the design example of the method according to FIG. 3.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

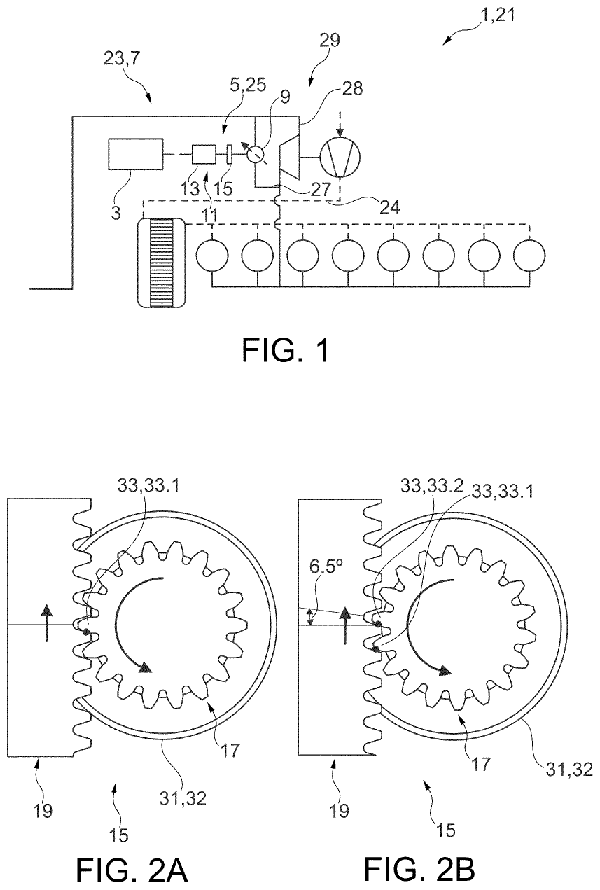

FIG. 1 is a schematic representation of one design example of an energy conversion device 1 with one design example of a control device 3 and a gas path control device 5.

Energy conversion device 1 includes a gas path 7 which in turn includes a gas path control device 5. Gas path control device 5 includes an actuating element 9 and an actuator 11 which is drive-operatively connected with actuating element 9, wherein actuator 11 is designed to adjust actuating element 9. Actuator 11 is designed to be controllable and has a motor 13 in combination with gearing 15, in particular a gear wheel 17, illustrated in FIGS. 2A, 2B. Motor 13 is drive-operatively connected with actuating element 9 via gearing 15. Actuating element 9 has optionally assigned to it a rack 19 which is also illustrated in FIGS. 2A, 2B, which engages with gear wheel 17. Gearing 15 includes in particular gear wheel 17 and rack 19 which engage with one another, meaning they mesh. Motor 13 is optionally an electric motor, in particular a stepping motor or a servo motor. Actuating element 9 is in particular a flap element or a valve piston or a valve tappet.

Control device 3 is operatively connected with gas path control device 5, in particular with actuator 11, in particular to control actuator 11 and to receive a current actuator position from actuator 11.

In the design example illustrated in FIG. 1, energy conversion device 1 is in the embodiment of an internal combustion engine 21, in particular a piston engine. In another design example, energy conversion device 1 can be in the embodiment of a fuel cell. Moreover, in the design example illustrated in FIG. 1, gas path 7 is an exhaust gas path 23 of internal combustion engine 21. In another design example, gas path 7 can be an air path 24 or a charge path, or an exhaust air path of energy conversion device 1. In the design example illustrated in FIG. 1, gas path control device 5 is a Wastegate-valve 25 which is arranged especially in a turbine bypass 27 of an exhaust gas turbine 28 of an exhaust gas turbo charger 29 of internal combustion engine 21. In another design example, gas path control device 5 is a flap device, in particular a throttle flap or exhaust gas flap, or another valve device, in particular a throttle valve.

Control device 3 is arranged in particular to carry out a method for monitoring a wear state of gas path control device 5, including the following steps: the actuator position of actuator 11 is detected in a time-dependent manner; on the basis of the time-dependently detected actuator position at least one wear state parameter is determined, and on the basis of at least one wear state parameter, the wear state is determined.

As the at least one wear state parameter, at least one state parameter is optionally determined, selected from the following group: a bearing state parameter of a bearing arrangement 31 of gas path control device 5 illustrated in FIGS. 2A, 2B, which in this case is a radial bearing arrangement 32 of gear wheel 17; and a gearing state parameter of gearing 15 of actuator 11. Optionally both state parameters—the bearing state parameter and the gearing state parameter—are determined as wear state parameters. In particular, the two state parameters are ORed with each other in order to decide on further actions subject to the status parameter that indicates the greater wear.

In particular, the at least one wear state parameter is compared with a predetermined wear state parameter threshold value, wherein the wear state is determined on the basis of the comparison.

The control device is arranged in particular, to optionally carry out at least one of the design examples of the method explained in further detail below, optionally both design examples in combination with each other, in particular in that the obtained wear state parameters are ORed with each other.

According to a first design example of the method, it is provided that, as the at least one wear state parameter, a bearing state parameter of a bearing arrangement 31, in particular of a radial bearing arrangement 32, of gas path control device 5 is determined, in that a momentary load variable of gas path control device 5 is determined on the basis of the time-dependently detected actuator position, wherein the momentary load variable is temporally integrated, from which a load integral L is obtained as the bearing state parameter. The momentary load variable is determined as a product of a temporal derivative of the actuator position, with a resistivity. Load integral L is calculated optionally according to the previously shown equation (1).

In a second design example which is discussed specifically by reference to the subsequent drawings of the method, it is provided that a gearing state parameter of gearing 15, in particular of gear wheel 17 of actuator 11 is determined as the at least one wear state parameter.

FIGS. 2A, 2B each is a detailed illustration of a gas path control device 5 with gearing 15, in particular gear wheel 17 and rack 19.

Same and functionally same elements are given the same designation in all drawings, so that reference can be made to prior descriptions.

Gear wheel 17 and rack 19 are in particular designed, arranged and coordinated with each other, that at most, two directly adjacent teeth 33 of gear wheel 17 engage with rack 19. For sake of clarity only two teeth 33 with the respective identification are shown in FIGS. 2A, 2B. Over a greater portion of partial distances of the regulating distance of actuator 11 only always one tooth 33 is engaged with rack 19, which is referred to as single-tooth engagement. Only over a smaller portion of partial distances of the regulating, two directly adjacent teeth 33 are engaged with rack 19, which is referred to as double-tooth engagement.

In FIG. 2A a single-tooth engagement is illustrated, wherein only one tooth 33, namely tooth 33.1 engages with rack 19. FIG. 2B illustrates a double-tooth engagement, wherein two directly adjacent teeth 33, namely first tooth 33.1 and a second tooth 33.2 which is located directly adjacent to first tooth 33.1 engage simultaneously with rack 19.

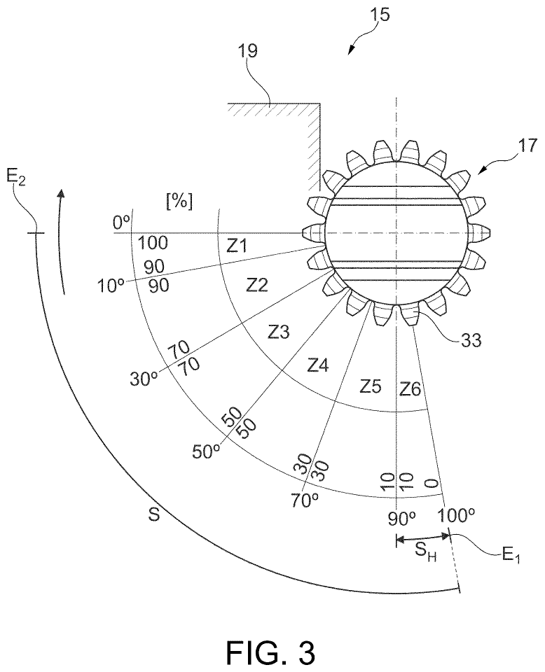

FIG. 3 is a schematic representation of the first part of an embodiment of a method for monitoring a wear state of gas path control device 5.

A regulating interval S of actuator 11 is herein divided into a plurality of partial regulating intervals Sᵢ. Regulating interval S equates to a complete regulating distance of actuator 11 from a first end position E₁ to a second end position E₂, which actuator 11 covers during operation of gas path control device 5 for adjustment of actuating element 9. Regulating interval S, can in particular be stated in angular degrees or in percentages, wherein in the latter case, for example first end position E₁ can be allocated a 0% value and second end position E₂ a 100% value. A momentary partial regulating interval S₁ of actuator 11 is detected in a time-dependent manner as the actuator position. FIG. 3 only shows a coarse division of regulating interval S into six primary partial regulating intervals, only one of which is designated SH for the sake of clarity, wherein each primary partial regulating interval is allocated to one of six teeth 33 which are identified as teeth Z1 to Z6, which successively engage with rack 19 when actuator 11 cycles through regulating interval S.

In fact, the division into the partial regulating intervals Sᵢ occurs more distinctly, that is, in particular into a larger number of partial regulating intervals Sᵢ, in particular optionally into thirty partial regulating intervals Sᵢ. in such a way that the partial regulating intervals Sᵢ on the one hand can have allocated to them single-tooth engagement and on the other hand double-tooth engagement. The number of partial regulating intervals into which regulating interval S can be divided is selected appropriately suitably, especially in such a way that certain partial regulating intervals S can have allocated to them explicitly double-tooth engagement.

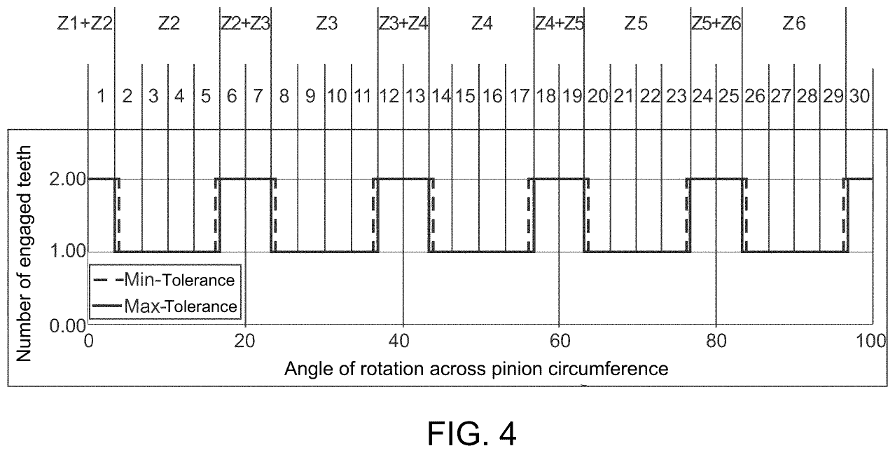

FIG. 4 is a second schematic representation of a second part of the design example of the method according to FIG. 3. It shows a tabular view of the thirty partial regulating intervals S₁, together with an allocation to which partial regulating intervals S₁ single-tooth engagement is assigned and to which partial regulating intervals S₁ double-tooth engagement is assigned. The six teeth shown in FIG. 3 are also identified with Z1 to Z6 in this case. The thirty partial regulating intervals respectively are designated with their index i, from 1 to 30. For example, double-tooth engagements are assigned to partial regulating intervals S₁, S₆, S₇, S₁₂, S₁₃, S₁₈, S₁₉, S₂₄, S₂₅ and S₃₀. The other partial regulating intervals respectively, have single-tooth engagement assigned to them. In another design example, a division of the regulating intervals into partial regulating intervals is however also possible, where changes between a single tooth engagement and a double tooth engagement are allocated to individual partial regulating intervals, regardless of the direction.

As the at least one gearing state parameter a frequency distribution of wear-critical events is now determined, selected from a group consisting of: inclusion of a wear-critical partial regulating interval by actuator 11; and a wear-critical partial regulating interval change. The wear-critical events are always counted, and a frequency distribution is determined, in particular according to a histogram. Alternatively, or additionally, an absolute frequency of the wear-critical events is determined.

In particular, wear-critical partial regulating interval changes are now identified within the scope of the method. In particular, partial regulating interval changes, that is, such changes from one partial regulating interval Sᵢ to a directly adjacent next partial regulating interval Sᵢ, are identified as wear-critical in which a change between a single-tooth engagement and a double-tooth engagement occurs. A wear-critical partial regulating interval change is thus in particular a change between a first partial regulating interval Sᵢ and a second partial regulating interval Sᵢ₊₁ or Sᵢ₊₂ immediately adjacent to the first partial regulating interval Sᵢ, in which either a single-tooth engagement exists in the first partial regulating interval Sᵢ and a double-tooth engagement exists in the second partial regulating interval Sᵢ₊₁ or Sᵢ₊₂, or vice versa, a single-tooth engagement exists in the second partial regulating interval Sᵢ₊₁ or Sᵢ₊₂ and a double-tooth engagement is exists in the first partial regulating interval Sᵢ, for example a change from S₁₃ to S₁₄ or from S₆ to S₅.

The frequency distribution of the wear-critical events is optionally determined in a tooth-specific manner for a plurality of teeth 33 of gear wheel 17. Alternatively, or in addition, the frequency distribution is determined in a tooth-pair specific manner for a plurality of pairs of directly adjacent teeth 33 of the gear wheel 17. Alternatively, or in addition, the frequency distribution of wear-critical events is determined globally for gear wheel 17. Alternatively, or in addition the absolute frequency of wear-critical events is determined in a tooth-specific manner for a plurality of teeth 33 of gear wheel 17. Alternatively, or in addition, the absolute frequency is determined in a tooth-specific manner for precisely one tooth 33 of gear wheel 17.

Alternatively, or in addition, the absolute frequency is determined in a tooth-pair specific manner for a plurality of directly adjacent pairs of teeth 33 of gear wheel 17. Alternatively, or in addition, the absolute frequency is determined in a tooth-pair specific manner for precisely one pair of directly adjacent teeth 33 of gear wheel 17. Alternatively, or in addition the absolute frequency of wear-critical events is determined globally for gear wheel 17.

The actuator position is optionally detected by actuator 11 itself, in particular if the motor of actuator 11 is a stepping motor or a servo motor.

The wear state is optionally determined locally in control device 3. Alternatively, or in addition, the wear state is determined remotely from energy conversion device 1, in particular in a remote computing device, in particular a provider or in a data cloud which is also referred to as Cloud.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for monitoring a wear state of a gas path control device of an energy conversion device having a gas path, the method comprising the steps of:
detecting, in a time-dependent manner, an actuator position of an actuator that is for adjusting an actuating element of the gas path control device;
determining at least one wear state parameter based on the actuator position which is detected in a time-dependent manner; and
determining the wear state by way of the at least one wear state parameter.

2. The method according to claim 1, wherein, as the at least one wear state parameter, at least one state parameter is determined that is selected from a group consisting of: a bearing state parameter of a bearing arrangement; and a gearing state parameter of a gearing of the actuator.

3. The method according to claim 2, wherein the bearing arrangement is a radial bearing arrangement of the gas path control device.

4. The method according to claim 1, wherein the at least one wear state parameter is compared with a predetermined wear state parameter threshold value, resulting in a comparison, wherein the wear state is determined based on the comparison.

5. The method according to claim 1, wherein, as the at least one wear state parameter, a bearing state parameter of a bearing arrangement of the gas path control device is determined, in that a momentary load variable of the gas path control device is determined based on the actuator position that is detected in a time-dependent manner, wherein the momentary load variable is temporally integrated, from which a load integral is obtained as the bearing state parameter.

6. The method according to claim 4, wherein the momentary load variable is determined as a product of a temporal derivative of the actuator position, with a resistivity.

7. The method according to claim 1, wherein at least one gearing state parameter of a gearing of the actuator is determined as the at least one wear state parameter, in that a regulating interval of the actuator is divided into a plurality of partial regulating intervals, wherein a momentary partial regulating interval of the actuator is detected as the actuator position in the time-dependent manner, wherein at least one of a frequency distribution and an absolute frequency of a plurality of wear-critical events is determined as the at least one gearing state parameter, wherein the plurality of wear-critical events are selected from a group consisting of: a wear-critical partial regulating interval by way of the actuator; and a wear-critical partial regulating interval change.

8. The method according to claim 6, wherein at least one of the frequency distribution and the absolute frequency of the plurality of wear-critical events is determined (i) in a tooth-specific manner for a plurality of teeth of the gearing of the actuator or (ii) globally for the gearing.

9. The method according to claim 1, wherein the actuator position is detected by the actuator.

10. The method according to claim 1, wherein the wear state is determined at least one of (i) locally in a control device of the energy conversion device that includes the gas path control device and (ii) remotely from the energy conversion device.

11. The method according to claim 10, wherein the wear state is determined remotely from the energy conversion device, in a remote computing device.

12. The method according to claim 11, wherein the wear state is determined remotely from the energy conversion device, in a provider or in a data cloud.

13. A control device for an energy conversion device having a gas path having a gas path control device, the control device comprising:
the control device, which is configured for carrying out a method for monitoring a wear state of the gas path control device of the energy conversion device having the gas path, the method including the steps of:
detecting, in a time-dependent manner, an actuator position of an actuator that is for adjusting an actuating element of the gas path control device;
determining at least one wear state parameter based on the actuator position which is detected in a time-dependent manner; and
determining the wear state by way of the at least one wear state parameter.

14. An energy conversion device, comprising:
a gas path having a gas path control device; and
a control device, which is configured for carrying out a method for monitoring a wear state of the gas path control device of the energy conversion device, the method including the steps of:
detecting, in a time-dependent manner, an actuator position of an actuator that is for adjusting an actuating element of the gas path control device;
determining at least one wear state parameter based on the actuator position which is detected in a time-dependent manner; and
determining the wear state by way of the at least one wear state parameter.
